(19) United States
(12) Patent Application Publication
(10) Pub. No.: US 2025/0386318 A1
(43) Pub. Date: Dec. 18, 2025

(54) BEAM PREDICTION BASED ON POSITIONING AND MOBILITY

(71) Applicant: InterDigital Patent Holdings, Inc., Wilmington, DE (US)

(72) Inventors: Haseeb Ur Rehman, Winnipeg (CA); Young Woo Kwak, Woodbury, NY (US); Nazli Khan Beigi, Longueuil (CA); Prasanna Herath, Laval (CA); Patrick Tooher, Montreal (CA); Tejaswinee Lutchoomun, Montreal (CA); Yugeswar Deenoo Narayanan Thangaraj, Chalfont, PA (US)

(73) Assignee: InterDigital Patent Holdings, Inc., Wilmington, DE (US)

(21) Appl. No.: 18/881,159

(22) PCT Filed: Aug. 2, 2023
(86) PCT No.: PCT/US2023/071525

§ 371 Date: Jan. 3, 2025

Related U.S. Application Data
(60) Provisional application No. 63/396,799, filed on Aug. 10, 2022.

(51) Int. Cl. H04W 64/00; H04B 7/08

(52) U.S. Cl. CPC H04W 64/00; H04B 7/088

(57) ABSTRACT

A WTRU may be configured to receive first configuration information associated with a channel state information reference signal (CSI-RS) resource set, a set of transmission configuration index (TCI) states, a set of probability thresholds, and/or a set of time durations. The WTRU may be configured to estimate a line of sight (LOS) probability of the WTRU based on one or more CSI-RS measurements. The WTRU may be configured to determine whether the estimated LOS probability is greater than or equal to a probability threshold from the set of probability thresholds. In response to determining that the estimated LOS probability is greater than or equal to the probability threshold, the WTRU may be configured to determine a time duration from the set of time durations based on the estimated LOS probability. The WTRU may be configured to predict a future TCI state applicable to an associated time instance.

### CROSS-REFERENCE TO RELATED APPLICATIONS

This application claims priority to U.S. provisional patent application No. 63/396,799, filed Aug. 10, 2022, which is incorporated herein by reference in its entirety.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long-Term Evolution (LTE) system). A wireless multiple-access communications system may include a number of base stations, each simultaneously supporting communication for multiple communication devices, which may be otherwise known as user equipment (UE).

Wireless communication systems may operate in mmW frequency ranges, e.g., 28 GHZ, 40 GHz, 60 GHz, etc. Wireless communications at these frequencies may be associated with increased signal attenuation (e.g., path loss), which may be influenced by various factors, such as temperature, barometric pressure, diffraction, etc. As a result, signal processing techniques, such as beamforming, may be used to coherently combine energy and overcome the path losses at these frequencies. Due to the increased amount of path loss in mmW communications systems, transmissions from the base station and/or the WTRU may be beamformed.

UEs may be mobile and traverse the coverage areas of different base stations of the wireless communications system. WTRU location may be important for various functions, e.g., location-based services, emergency response services, etc. Determining the location of WTRUs operating in wireless networks may be a challenge owing to the mobility of users and the dynamic nature of both the environment and radio signals. Traditional wireless networks may determine the WTRU location using dedicated signaling, e.g., by broadcasting positioning reference signals (PRSs) throughout a coverage area.

### SUMMARY

According to one exemplary aspect, the disclosure relates to a method and apparatus for the prediction of beams. For example, a WTRU may implement receiving an RS signal, wherein the RS signal may be periodic, semipersistent, or aperiodic and predicting a directional information based on measurements performed by the WTRU and the received RS signal. In an example, the WTRU may further implement enabling reporting by the WTRU of the one or more predictions based on one or more LOS probability thresholds and reporting one or more directional information via a report, wherein the report is based on multiple parameters with different LOS probability thresholds. Additionally, the WTRU may implement reporting a beam based on speed and position information and reporting a best DL beam for a future time based on speed and position information.

A WTRU may be configured to receive first configuration information associated with a channel state information reference signal (CSI-RS) resource set, a set of transmission configuration index (TCI) states, a set of probability thresholds, and/or a set of time durations. The set of time durations may include a first time duration associated with a first range of LOS probabilities and a second time duration associated with a second range of LOS probabilities The WTRU may be configured to determine one or more CSI-RS measurements associated with one or more of the CSI-RSs in the CSI-RS resource set. The one or more CSI-RS measurements may be determined based on a received TCI state or an intermediate TCI state between the received TCI state and the future TCI state. The one or more CSI-RS measurements may include a reference signal received power (RSRP), a signal to interference noise ratio (SINR), a reference signal received quality (RSRQ), and/or a channel quality indicator (CQI). The WTRU may be configured to estimate a line of sight (LOS) probability of the WTRU based on the one or more CSI-RS measurements. The estimated LOS probability may be associated with the received TCI state or an intermediate TCI state between the received TCI state and the future TCI state. The WTRU may be configured to determine whether the estimated LOS probability is greater than or equal to a probability threshold from the set of probability thresholds.

In response to determining that the estimated LOS probability is greater than or equal to the probability threshold, the WTRU may be configured to determine a time duration from the set of time durations based on the estimated LOS probability. The determined time duration may be proportional to the estimated LOS probability. The WTRU may be configured to predict a future TCI state applicable to an associated time instance. The associated time instance may be determined based on the current time and/or the determined time duration. The WTRU may be configured to send the predicted future TCI state and the associated time instance to the network. In response to determining that the estimated LOS probability is less than the probability threshold, the WTRU may be configured to send an indication that the estimated LOS probability is less than the probability threshold to the network. The WTRU may be configured to send CSI information of a subset of the one or more measured CSI-RSs based on second configuration information. Positioning information of the WTRU may include one or more of a direction of motion, a position, or a speed. The WTRU may be configured to estimate the LOS probability of the WTRU, a direction of motion of the WTRU, a position of the WTRU, and a speed of the WTRU in a plurality of directional axes with respect to a second device.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating a WTRU within an area associated with a plurality of beams from a base station.

FIG. 3 is a flow chart depicting an example method of predicting a TCI state based on estimated line of sight (LOS) probability.

### DETAILED DESCRIPTION OF THE INVENTION

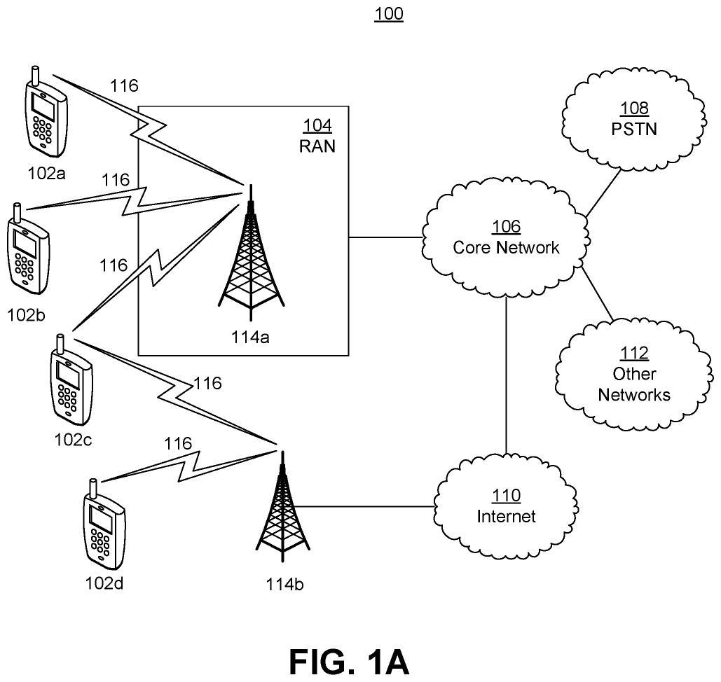

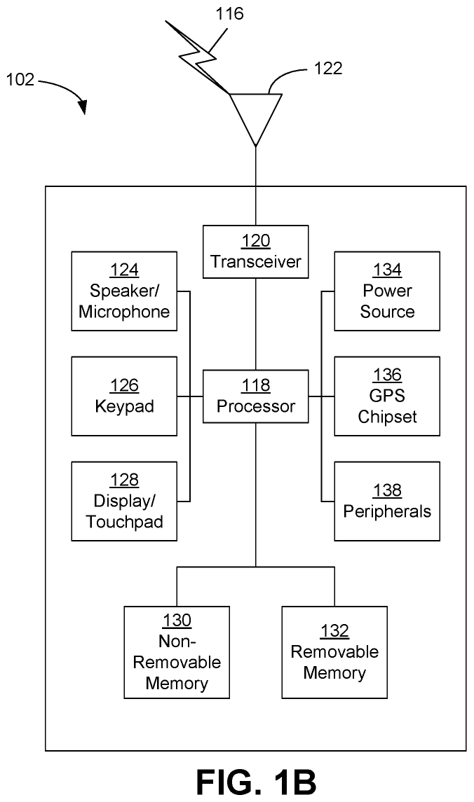

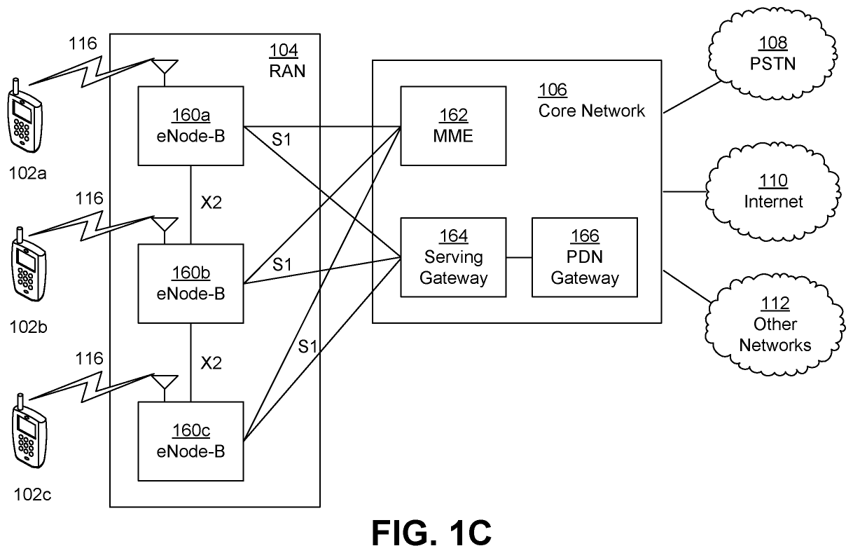

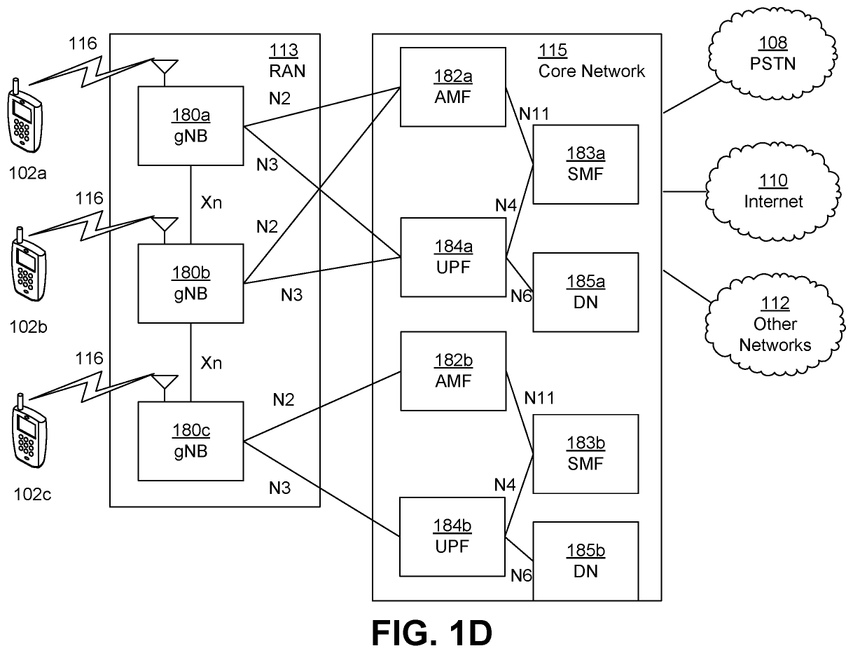

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (Qos) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b. 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a. 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The present disclosure relates generally to a device and method for beam prediction. More specifically, the present technique relates to predicting beams based on positioning and mobility.

In examples, conventional beam selection may consume high time-frequency resources, for example, for high mobility WTRU. In an example, using Artificial Intelligence (AI)/Machine Learning (ML) (AI/ML) models/algorithms, the position, direction of motion, and/or speed of a WTRU may be estimated using (e.g. significantly) less reference signal (RS) resources than required for conventional beam selection. In an example, implementations may comprise new types of channel state information (CSI), predicted-beam reporting and/or selection solutions, and/or a mechanism allowing an option to use conventional methods in case of a failure. In an example, a solution may be provided to efficiently support position-based CSI and/or beam indication/reporting.

CSI measurement and reporting for WTRU motion may be performed. For example, a WTRU may be configured to receive a pilot RS from one or more sources. The pilot RS may be periodic, semi-persistent, and/or aperiodic. For example, the WTRU may perform one or more relevant measurements (e.g., using the pilot RS). The one or more relevant measurements may include a communication delay, a doppler frequency, and/or the like). For example, the WTRU may predict and/or estimate a direction of motion, a relative position, and/or a speed associated with the WTRU in one or more directional axes based on the measurements and/or pilot signal.

The WTRU may be configured to enable WTRU reporting of WTRU position and/or speed prediction based on a LOS probability threshold. WTRU reporting/indication of LOS probability may be based on location services. For example, WTRU reporting/indication of LOS probability may be based on WTRU CSI reporting.

A base station (e.g., gNB) may send a confirmation to the WTRU based on location services and/or WTRU reporting. For example, the base station (e.g., gNB) may send the confirmation to the WTRU in response to receipt of the WTRU report of position and/or speed prediction.

A WTRU may determine a LOS probability. For example, the WTRU's CSI reporting mode of operation (e.g., conventional or AI/ML based) may be based on LOS probability. When the LOS probability is greater than P1, the WTRU may use an AI/ML mode of CSI reporting. When the LOS probability is less than P2, the WTRU may use a conventional mode of CSI reporting. P2 may be less than LOS probability, which may be less than P1, in which case the WTRU may use either AI/ML or conventional reporting with larger and non-overlapping time periods for CSI reporting.

The WTRU may report (e.g., send CSI reporting) in an UL resource after X symbols, slots, or ms from the WTRU reporting/CSI reporting of LOS probability. For example, the WTRU may report in an UL resource after X symbols, slots, or ms from the gNB confirmation (e.g., if an optional confirmation received). For example, the WTRU may be indicated or configured with a value of X. For example, the WTRU may determine X based on LOS probability. X may be equal to X1 for LOS probability P1 and/or X may be equal to X2 for LOS probability P2, where, for example, X1 may be less than X2 and/or P1 may be less than P2.

The WTRU may report LOS probability, AI/ML CSI information, and/or conventional CSI information in the same UL resource (e.g. multiple parts). When LOS probability is less than a threshold, the WTRU may receive the pilot RS in an increased number of resources and/or may perform another measurement to determine a new LOS probability.

The WTRU may report the direction of motion, relative position, and/or speed of the WTRU. For example, multiple parts of an UL resource may be used for the report. The LOS probability may be send in a first part of the UL resource. The WTRU direction of motion, relative position, and/or speed may be sent in a second part of the UL resource. The WTRU may report different parameters (e.g., direction of motion, relative position, and/or speed) with different LOS thresholds.

For example, if LOS probability is less than a first value (e.g., X), the WTRU may report WTRU relative position. If LOS probability is greater than the first value (e.g., X), the WTRU may report direction of motion, relative position, and/or speed. If LOS probability is greater than a second value (e.g., Y, where the LOS probability is equal to X+Y), the WTRU may report the direction of motion, relative position, and/or speed.

The WTRU may report direction of motion and/or speed based on an estimated speed. For example, the WTRU may report direction of motion and/or speed if the WTRU's mobility is greater than a threshold. In one part (e.g., Part 1), the WTRU may indicate whether or not the WTRU reports direction of motion and/or speed. For example, the WTRU may report whether or not estimated speed is greater than the threshold and/or may report a WTRU relative position. In another part (e.g., Part 2), the WTRU may report the direction of motion, relative position, and/or speed (for example, if not reported in another part (e.g. Part 1).

The WTRU may report the direction of motion and/or speed based on one or more of (e.g. both) an LOS probability and/or a WTRU speed. In an example, the WTRU may report the direction of motion and/or speed in a first part based on the LOS probability and there may be a WTRU indication on a report associated with a direction of motion/speed report. The WTRU may report the direction of motion and/or speed based on WTRU direction of motion, relative position, and/or speed in a second part.

In another example, the WTRU may report the direction of motion and/or speed based on the LOS probability in a first part. The WTRU may report the direction of motion and/or speed based on WTRU direction of motion and/or speed in a second part. The WTRU may report the direction of motion and/or speed based on WTRU direction of motion, relative position, and/or speed in a third part.

In another example, the WTRU may report the direction of motion and/or speed based on the LOS probability in a first part. The WTRU may report the direction of motion and/or speed based on WTRU direction of motion and/or speed, and the WTRU relative position in a second part. the WTRU may report the direction of motion and/or speed based on WTRU direction of motion and/or speed in a third part.

A WTRU may report a direction of motion, a relative position, and/or a speed. The WTRU may report the WTRU direction of motion using bitwise direction of motion (e.g., where 0 represents the WTRU moving towards a gNB, 1 represents the WTRU moving away from gNB, and the like) for one or more directional axes. For example, the WTRU may report 1-bit, 2-bit, and/or 3-bit direction of motion based on the number of sources of pilot signal (e.g., RS). For example, if there is a multi-TRP configuration, the WTRU may report direction of motion using a number of bits up to the number of sources of RS.

The WTRU may receive an indication of activation and/or deactivation of the RSs for reporting bitwise direction of motion. The WTRU may determine a number of bits for the reporting based on the configured and/or activated RSs.

The WTRU may report its direction of motion, for example, when the direction of motion changes from the previously reported direction of motion. For example, the WTRU's report may be implementation-based. The WTRU's report may be based on one or more of a RSRP, a RSRQ, or a SINR. The WTRU may measure a change of a measurement trend (e.g., a number of continuous increases/decreases is greater than N). The WTRU's report may be based on whether the WTRU may measure a change of a measurement trend (e.g., number of continuous increases/decreases is greater than N).

The WTRU may report direction of motion based on the quality of current beam. For example, the WTRU may report direction of motion when the quality (e.g., RSRP) of the current beam falls below a threshold. The WTRU may report quality measurement when directions of motion are changed for one or more RSs. For example, the WTRU may report quality measurement based on one or more of RSRP, RSRQ, or SINR/CQI. For example, the WTRU may report quality measurement based on LOS probability. When LOS probability is greater than a threshold, the WTRU may indicate an AI/ML model predicted DL beam which may be applicable at a future time instant. The WTRU may report an RSRP, RSRQ, SINR, and/or CQI of the predicted beam. The WTRU may report quality measurement based on a change in a WTRU relative position and/or speed for one or more RSs. The WTRU may use a 1-bit indication for direction of motion change in a first part. The WTRU may use a 1-bit indication for the direction of motion, relative position, and/or speed in a second part. In another example, the WTRU may use a 1-bit indication for direction of motion change in a first part, use a 1-bit indication for the direction of motion bits in a second part, and use an indication for a relative position and/or speed report in the changed direction of motion in a third part. For example, if the direction of motion changed for x direction and remains the same for y direction, the WTRU may report relative position and/or speed in the x direction in part 3. The WTRU may report a quality measurement based on a change in a WTRU (e.g., [min, max]) relative position range for one or more RSs.

In an example, the WTRU may report its relative position. For example, the WTRU may be configured with max distance and/or min distance from a gNB and a granularity level (e.g., number of bits for reporting distance from gNB and/or sign bit) for reporting the relative position of the WTRU.

The determination of a coordinate system may be used for reporting a gNB indication and/or configuration. The determination of a coordinate system may be used for reporting of a WTRU indication and/or recommendation. For example, the WTRU may recommend a coordinate system for a reporting based on one or more measurements. The WTRU may be configured and/or indicated with one or more conditions to change a coordinate system. For example, the WTRU may determine whether one or more parameters change. The parameters may include radius, angles, WTRU position (e.g., x, y and/or z), and/or the like. For example, if the difference in radius and/or angle is less than a threshold, the WTRU may determine that the radius and/or angle is not changing.

For example, the radius and/or angle may not change when the WTRU changes the coordinate system from Cartesian to Polar. For example, positions in axes (e.g., x, y, and z) may not change when the WTRU changes the coordinate system from Polar to Cartesian.

The WTRU may be indicated and/or configured with a rule to estimate a distance (e.g., radius) between the gNB and the WTRU. For example, the WTRU may be indicated and/or configured to estimate the distance (e.g., radius) between the gNB and the WTRU based on one or more of LOS probability, pathloss, or RSRP.

The WTRU may determine a granularity level (e.g., number of bits used for reporting) according to the beam widths (e.g., based on frequency ranges, SCSs, and/or the like). The WTRU may report its position for one or more directional axes up to the number of configured pilot RS sources. For example, the WTRU may report its position in (e.g., at most) two directional axes for 2-TRPs. The WTRU may report its range of position in one or more directional axes. The WTRU may report minimum and maximum distance from the gNB within a time period. The WTRU may report its range in different directional axes based on the number of sources of pilot RS.

The WTRU may report its position based on its current position and/or a previously reported position. For example, the WTRU may report its position if the difference between current and previously reported position is greater or smaller than a position threshold. The WTRU may report its position if the distance from the WTRU to the gNB is higher or lower than a distance threshold. The WTRU may report a relative position based on a current beam. For example, the WTRU may report relative position when the quality (e.g., RSRP) of the current beam falls below a threshold. For example, the WTRU may report relative position when the WTRU's current beam changes (e.g., a different TCI-state activated).

A WTRU may be configured to report its speed. The WTRU may report its position for two or more time instants, for example, together in a single report. The WTRU may report a time interval (e.g., symbols/slots/ms) between the reported positions. For example, the WTRU may be configured to report two positions estimated at predefined time intervals. The WTRU may be configured with max speed and/or min speed and a granularity level (e.g., a number of bits for reporting speed and/or sign bit) for reporting the speed. The WTRU may determine a granularity level according to the beam widths (e.g., based on frequency ranges, SCSs, and the like). For example, the WTRU may determine a granularity level for reporting the WTRU speed from the granularity level configured for position reporting. For example, the WTRU may determine the granularity level for speed based on the configured min and max speed and/or the granularity level of position reporting.

The WTRU may report its speed periodically or through an aperiodic trigger. For example, the WTRU may report its speed based on the difference between its current speed and a previously reported speed. The WTRU may report its speed if the difference between the current and the previously reported speed is greater or smaller than a configured speed threshold. The WTRU may report the difference between the current speed and the previously reported speed. The WTRU may report speed based on the quality of a current beam. For example, the WTRU may report speed when the quality (e.g., RSRP) of the current beam falls below a threshold. For example, the WTRU may report its speed based on a trigger in DCI.

A WTRU may perform conditional beam measurement and/or reporting. The WTRU may start and/or stop beam measurements and/or beam reporting based on an estimated speed and/or an estimated position. For example, if the WTRU estimates its current position at beam #2 and its direction of motion as beam #1->2->3->4->5, the WTRU may start measurement and reporting of beam #5, 6, 7 based on its speed of motion. The WTRU may stop measurement and/or reporting of beam #1->2->3 based on its speed of motion.

The WTRU may start and/or stop receiving PDSCH in the corresponding RS resources for which the WTRU may start and/or stop measuring and/or reporting. The WTRU may change its RS measurement and reporting behavior based on a relative position range (e.g., [min, max]). The WTRU may stop and/or decrease the frequency of measurement and/or reporting of RSs that are outside of the relative position range (e.g., [min, max]). the WTRU may start and/or revert decrease in frequency of measurement and/or reporting of RSs if the change in WTRU's relative position is greater than a threshold. The WTRU may decrease the measurement and/or reporting frequency of RSs based on the relative position range (e.g., [min, max]) and direction of motion. The WTRU may stop and/or decrease the frequency of measurement and/or reporting of RSs that are outside of the relative position range (e.g., [min, max]) and/or are opposite to the direction of motion. The WTRU may start and/or revert decrease in frequency of measurement and/or reporting of RSs if the WTRU's direction of motion changes. For example, the WTRU may start and/or revert decrease in frequency of measurement and/or reporting of RSs if the LOS probability is less than a threshold (e.g. WTRU loses confidence in its position/speed estimate).

A WTRU may report a best DL beam for a future time (e.g., future time instant). For example, the WTRU may report the best DL beam for a future time instant based on the predicted position and/or speed.

The WTRU may be configured with an AI/ML model-based mapping between position(s) and TCI-states. The WTRU may report its LOS probability and/or direction of motion/relative position/speed/and the beam qualities for model (e.g., AI/ML model) training at the gNB. The WTRU may receive the trained AI/ML model from gNB. When LOS probability is less than a threshold (e.g., AI/ML mode of operation), the WTRU may report a future TCI-state output by AI/ML in advance (e.g., X symbol/slot/ms before it may be applicable).

For example, the WTRU may be indicated and/or configured with a time delay for application of a future TCI state (e.g. a value of ‘X’)I. A TCI state may indicate one or more of a plurality of beams that originate from a TRP (e.g., such as a base station, eNB, etc.). The time delay may be a time duration between a current time and a time instance associated with the future TCI state. For example, the time duration, X may be the time delay from a current time instance for use of the future TCI state. For example, the WTRU may determine X based on LOS probability. For example, X may be X1 for LOS probability P1 and X may be X2 for LOS probability P2, where, for example, X1 may be less than X2 and P1 may be less than P2.

For example, the WTRU may determine ‘X’ based on LOS probability and WTRU's mode of operation for beam management (BM) (e.g., AI/ML or conventional). For example, for high LOS probability (e.g., LOS probability greater than a LOS probability threshold) and conventional BM mode of operation, the WTRU may determine a large X (e.g., greater than a threshold X value). A large X value may account for time to change mode of operation to AI/ML. For example, for low LOS probability (e.g., LOS probability less than or equal to the LOS probability threshold) and AI/ML mode of operation, the WTRU may determine a small X (e.g., less than or equal to the threshold X value). A small X value may account for time to change mode of operation to conventional. For example, the WTRU may request retraining of an AI/ML model based on accuracy. The WTRU may indicate a 1-bit accuracy of AI/ML model if the difference in quality of the predicted beam and the best beam is below a threshold for N number of times.

The WTRU may train an AI/ML model for predicting the best beam TCI-state based on the WTRU position. For example, the WTRU may train an AI/ML model that outputs a TCI-state based on position, speed, direction of motion, and/or LOS probability.

When LOS probability is greater than a threshold (e.g., AI/ML mode of operation), the WTRU may report a future TCI-state output by AI/ML in advance (e.g., X symbol, slot, and/or ms before it may be applicable). For example, the WTRU may be indicated or configured with a time delay for application of the future TCI state (e.g., value of ‘X’). The WTRU may determine X based on LOS probability. For example, X may be equal to X1 for LOS probability P1 and X may be equal to X2 for LOS probability P2, where, for example, X1 may be less than X2 and P1 may be less than P2. The WTRU may determine ‘X’ based on LOS probability and/or WTRU's mode of operation for beam management. For high LOS probability (e.g., LOS probability greater than a threshold LOS probability) and conventional BM mode of operation, the WTRU may determine a large X (e.g. to account for time to change mode of operation to AI/ML). For low LOS probability (e.g., LOS probability less than or equal to the threshold LOS probability) and AI/ML mode of operation, the WTRU may determine a small X (e.g. to account for time to change mode of operation to conventional). The WTRU may retrain the AI/ML model when TCI-state beam mapping changes and/or when the WTRU moves to a new serving cell.

The WTRU may retrain the AI/ML model if the WTRU receives a new RS configuration for QCL Type-D of a TCI state. The WTRU may retrain the AI/ML model if the accuracy of the AI/ML model falls below a threshold. The WTRU may retrain the AI/ML model if the difference in quality of the predicted beam and the best beam falls below a threshold for N number of times.

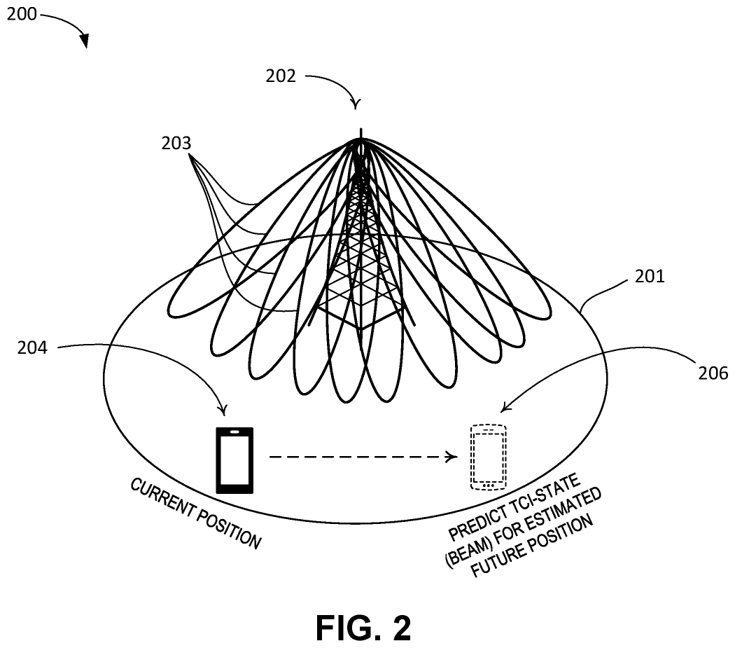

FIG. 2 depicts an example method 200 of a WTRU 204 predicting a TCI state 203 for an estimated future position 206. For example, a gNB 202 may transmit via a plurality of TCI states 203 (e.g., beams). The gNB 202 may be associated with a coverage area 201. For example, the plurality of TCI states 203 may cover the coverage area 201. The WTRU 204 may receive one or more transmissions from the gNB 202 a first TCI state of the plurality of TCI states 202 at a current position (e.g., location). The WTRU 204 may estimate a future position 206, for example, based on the current position of the WTRU 204, a direction of motion of the WTRU 204, and/or a speed of the WTRU 204. The WTRU 204 may predict a TCI state associated with the future position 206. For example, the WTRU 204 may predict a TCI state based on determining that the WTRU 204 will be within a beam area at the future time instant.

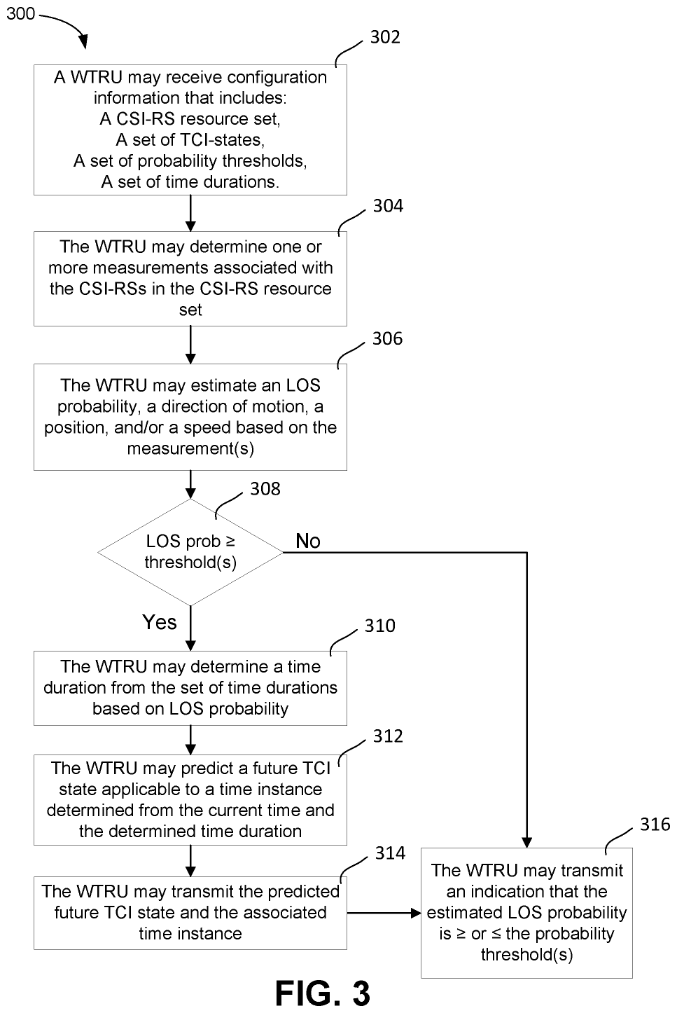

FIG. 3 depicts an example process 300 for a WTRU to predict a future TCI state based on an estimated LOS probability. At 302, the WTRU may receive configuration information. The configuration information may include a CSI-RS resource set, a set of TCI states, a set of probability thresholds, and/or a set of time durations. The set of time durations may include a first time duration associated with a first range of LOS probabilities and a second time duration associated with a second range of LOS probabilities. For example, the first time duration may be applied to a LOS probability within the first range of LOS probabilities and the second time duration may be applied to a LOS probability within the second range of LOS probabilities. At 304, the WTRU may determine one or more measurements associated with the CSI-RSs in the CSI-RS resource set. For example, the WTRU may determine one or more CSI-RS measurements associated with the one or more CSI-RSs in the CSI-RS resource set based on a received TCI state. The one or more CSI-RS measurements may include a RSRP, a SINR, a RSRQ, and/or a CQI.

At 306, the WTRU may estimate, based on the one or more CSI-RS measurements, a LOS probability of the WTRU, a direction of motion of the WTRU, a position of the WTRU, and/or a speed of the WTRU. For example, the WTRU may estimate, at 306, the LOS probability of the WTRU, the direction of motion of the WTRU, the position of the WTRU, and/or the speed of the WTRU in a plurality of directional axes with respect to a second device. The second device may be fixed in position. For example, the second device may be a base station, a gNB, and/or a TRP. In examples, the estimated LOS probability, estimated at 306, may be associated with the received TCI state or an intermediate TCI state between the received TCI state and the future TCI state. At 308, the WTRU may determine whether the LOS probability, estimated at 306, is greater than or equal to a probability threshold of the set of probability thresholds.

When the LOS probability is greater than or equal to the threshold, the WTRI may determine, at 310, a time duration from the set of time durations based on the estimated LOS probability. For example, the WTRU may determine, at 310, the time duration in response to determining, at 308, that the estimated LOS probability is greater than or equal to the probability threshold. The time duration, determined at 310, may be proportional to the estimated LOS probability. For example, the time duration may be longer for higher LOS probabilities. At 312, the WTRU may predict a future TCI state applicable to a time instance (e.g., a future time instant) determined from the current time and the determined time duration. The WTRU may use an AI/ML model to predict the TCI state for the time instance based on a predicted position and/or speed/velocity of the WTRU. For example, the WTRU may be configured with an AI/ML model to predict the mapping between a WTRU's future location and the future TCI state. At 314, the WTRU may transmit the predicted future TCI stat and the associated time instance. At 316, the WTRU may transmit an indication that the estimated LOS probability is greater than or equal to the probability threshold.

When the LOS probability is less than the probability threshold, the WTRU may transmit, at 316, an indication that the estimated LOS probability is less than the probability threshold. For example, the WTRU may transmit, at 316, the indication in response to determining, at 310, that the estimated LOS probability is less than the probability threshold. The WTRU may be configured to send CSI information of a subset of the one or more measured CSI-RSs based on second configuration information. The second configuration information may include a gNB configuration and/or positioning information of the WTRU. The positioning information of the WTRU may include one or more of a direction of motion of the WTRU, a position of the WTRU, or a speed of the WTRU.

In examples, RAN study item on Artificial Intelligence (AI)/Machine Learning (ML) for NR air interface may be used. For example, beam management may be selected as one of the target use cases for AI/ML for air interface, and this technology may be a great foundation in improving performance and complexity in conventional beam management aspects, including, for example, beam prediction in time, and/or spatial domain for overhead and latency reduction, beam selection accuracy improvement, and so forth. In an example, the conventional (non-AI/ML) beam selection may be based on beam sweeping at gNB-side and WTRU-side. In an example, beam selection for a moving WTRU may take higher time-frequency resources for continuously adjusting the beams for maintaining a reliable connection. In an example, for high mobility WTRUs (e.g., WTRUs on highways, highspeed train, and the like) where a major chunk of resources may be used for beam selection/adjustment, beam selection for a moving WTRU may be difficult.

In examples, using AI/ML models/algorithms, the position, direction of motion and speed of a WTRU may be estimated based on pilot RSs and CSI measurements using (e.g., significantly) less RS resources than required for conventional beam selection. In an example, the estimated positional parameters may be used to predict future beams. In an example, it may be required to have new types of CSI and predicted-beam reporting/selection solutions and a mechanism to fallback to conventional methods in case of a failure.

Efficient support for position-based (e.g., position and/or direction of motion) CSI reporting may be provided. Efficient support for reporting and/or indication of position and/or speed-based predicted beams may be provided.

One or more CSI reporting modes (e.g., conventional or AI/ML-based) may be selected based on accuracy thresholds. One or more types of parameters may be determined to be included in the CSI report and their indication may be provided herein. Methods to report a WTRU's direction of motion, position, and/or speed may be provided. Dynamic measurement and/or reporting of beam RSs based on position information may be provided. For example, methods to train an AI/ML model at both the WTRU and the gNB may be used. For example, predicted-beam reporting mechanisms may be used.

In examples, herein, ‘a’ and ‘an’ and similar phrases may be interpreted as ‘one or more’ and ‘at least one’. In an example, any term which ends with the suffix ‘(s)’ may be interpreted as ‘one or more’ and ‘at least one’. In examples, the term ‘may’ may be interpreted as ‘may, for example’.

In examples, artificial intelligence may be broadly defined as the behavior exhibited by machines. Such behavior may, for example, mimic cognitive functions to sense, reason, adapt, act, and/or the like.

In examples, machine learning may refer to type of algorithms that solve a problem based on learning through experience (‘data’), without explicitly being programmed (‘configuring set of rules’). For example, machine learning may be considered as a subset of AI. In an example, different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, an unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, a semi-supervised learning approach may use a combination of a small amount of labeled data with a large amount of unlabeled data during training. In an example, semi-supervised learning may fall between unsupervised learning (e.g. with no labeled training data) and supervised learning (e.g. with only labeled training data).

In examples, deep learning may refer to a class of machine learning algorithms that employ artificial neural networks (specifically DNNs) which may be loosely inspired from biological systems. For example, the Deep Neural Networks (DNNs) may be a special class of machine learning models inspired by the human brain wherein the input may be linearly transformed and pass-through non-linear activation function multiple times. In an example, DNNs may typically comprise multiple layers where each layer may comprise linear transformation and given non-linear activation functions. The DNNs may be trained using the training data via back-propagation algorithm. In an example, DNNs may show state-of-the-art performance in variety of domains, e.g., speech, vision, natural language etc. and for various machine learning settings supervised, unsupervised, and semi-supervised. In an example, the term AIML based methods/processing may refer to realization of behaviors and/or conformance to requirements by learning based on data, without explicit configuration of sequence of steps of actions. In an example, such methods may enable learning complex behaviors which may be difficult to specify and/or implement when using legacy methods.

In examples, a WTRU may transmit or receive a physical channel or reference signal according to at least one spatial domain filter. In an example, the term “beam” may be used to refer to a spatial domain filter.

In examples, the WTRU may transmit a physical channel and/or signal using the same spatial domain filter as the spatial domain filter used for receiving an RS (such as CSI-RS) and/or a SS block. In an example, the WTRU transmission may be referred to as “target”, and the received RS or SS block may be referred to as “reference” or “source”. In an example, the WTRU may be said to transmit the target physical channel and/or signal according to a spatial relation with a reference to such RS or SS block.

In examples, the WTRU may transmit a first physical channel or signal according to the same spatial domain filter as the spatial domain filter used for transmitting a second physical channel or signal. In an example, the first and second transmissions may be referred to as “target” and “reference” (or “source”), respectively. In examples, the WTRU may be said to transmit the first (e.g. target) physical channel and/or signal according to a spatial relation with a reference to the second (e.g. reference) physical channel and/or signal. In an example, a spatial relation may be implicit, configured by RRC or signaled by MAC CE or DCI. For example, a WTRU may implicitly transmit PUSCH and DM-RS of PUSCH according to the same spatial domain filter as an SRS indicated by an SRI indicated in DCI and/or configured by RRC. In an example, a spatial relation may be configured by RRC for an SRS resource indicator (SRI) and/or signaled by MAC CE for a PUCCH. In an example, such a spatial relation may also be referred to as a “beam indication”.

In examples, the WTRU may receive a first (e.g. target) downlink channel and/or signal according to the same spatial domain filter or spatial reception parameter as a second (e.g. reference) downlink channel or signal. For example, such association may exist between a physical channel such as PDCCH or PDSCH and its respective DM-RS. In an example, when the first and second signals are reference signals, such association may exist when the WTRU may be configured with a quasi-colocation (QCL) assumption type D between corresponding antenna ports. In an example, such association may be configured as a TCI (transmission configuration indicator) state. In an example, a WTRU may be indicated an association between a CSI-RS or SS block and a DM-RS by an index to a set of TCI states that may be configured by RRC and/or signaled by MAC CE. In an example, such indication may also be referred to as a “beam indication”.

Herein, a TRP (e.g., transmission and reception point) may be interchangeably used with one or more of TP (transmission point), RP (reception point), RRH (radio remote head), DA (distributed antenna), BS (base station), a sector (of a BS), and a cell (e.g., a geographical cell area served by a BS), but still consistent with this invention. Herein, Multi-TRP may be interchangeably used with one or more of MTRP, M-TRP, and multiple TRPs, but still consistent with this invention.

In examples, a WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

Herein, a reference signal may be interchangeably used with one or more of following: Sounding reference signal (SRS); Channel state information-reference signal (CSI-RS); Demodulation reference signal (DM-RS); Phase tracking reference signal (PT-RS): Synchronization signal block (SSB).

CSI measurement and reporting may be provided for WTRU motion. A WTRU may receive one or more pilot RSs from one or more sources (e.g., TRPs). The one or more pilot RSs may be one or more of periodic RSs (e.g. RRC configured), semi-persistent RSs (e.g. MAC-CE activated/deactivated), and aperiodic RSs (e.g. DCI indicated). The WTRU may perform CSI measurements (e.g., RSRP, SINR, RSRQ, CQI, doppler frequency, communication delay) on the RSs. The WTRU may estimate and/or predict its position, direction of motion, speed, and/or LOS probability based on the measurements. The WTRU may input the received RS and/or CSI measurements to an AI/ML model/algorithm, for example, to predict and/or estimate its position, direction of motion, and/or speed.

A WTRU may indicate, as a part of its capability information, that the WTRU may determine if a reference signal may be received with Line of Sight (LOS) propagation path (e.g., a direct path between transmitter and receiver). The WTRU may receive a configuration of a LOS probability indication from a gNB based on the capability information. The WTRU may derive a LOS indication (e.g., a hard LOS indication) such that the value of 0 may indicate an NLOS (Non-Line-of-Sight) path and a value of 1 may indicate an LOS propagation path. The WTRU may derive a soft LOS indication that indicates a likelihood of LOS path (e.g., a value in the range between 0 and 1, wherein 0 may refer to NLOS path, 1 may refer to LOS path, values in-between may refer to varying degrees of confidence in the WTRU estimation of LOS probability). The WTRU may indicate the capability associated with LOS determination when the location services may be enabled and/or available. The WTRU may indicate the capability associated with LOS determination, for example, if explicitly requested by the gNB.

The WTRU may be configured to determine LOS probability at the granularity of TRP (e.g., determine a LOS probability per TRP). Additionally or alternatively, the WTRU may be configured to determine LOS probability at the granularity of RSs (e.g., determine a LOS probability per RS). For example, the WTRU may determine a LOS probability specific to different beams from the same TRP. The WTRU may receive a plurality of RSs. A subset of the RSs may be configured for LOS determination. A subset of RSs configured for LOS determination may be configured as a part of CSI configuration via RRC reconfiguration message. The WTRU may be configured to determine LOS probability associated with each of the RS in the configured subset of RSs. The WTRU may be dynamically configured to enable LOS determination for the subset of RSs. In examples, the WTRU may receive a MAC control element to activate the LOS determination for subset of RSs. In examples, the WTRU may receive a DCI (e.g., as part of an aperiodic CSI request) to activate LOS determination for subset of RSs.

A WTRU may be configured to perform one or more actions based on the determination of presence of LOS path, likelihood of LOS path, and/or probability of LOS path. For example, such actions may be associated with transmitting a report that may include one or more of the following: WTRU speed, WTRU movement direction, WTRU position, indicating the LOS probability, and/or adapting the CSI reporting behavior. Adapting the CSI reporting behavior may include adapting the mode of CSI reporting and/or adapting the content of a CSI report. The content of the CSI report may include a LOS indication, resources used for CSI reporting, periodicity of CSI reporting, etc. The WTRU may be configured to determine the LOS probabilities dynamically (e.g., upon receiving an indication in a DCI). In examples, the WTRU may be configured to determine LOS probabilities when a CSI report is triggered. In examples, the WTRU may be configured to determine LOS probabilities semi-statically (e.g., for every n time units and/or based on a timer configured by RRC configuration).

A WTRU may be configured to transmit a CSI report using a first mode of reporting and/or a second mode of reporting. The first mode of reporting may correspond to generation of at least a part of a CSI report using an AI/ML model. The second mode of reporting may correspond to generation of a CSI report using a conventional mode (e.g., release 15, 16, 17 etc.) of CSI reporting. The WTRU may determine the CSI reporting mode based on one or more preconfigured conditions. For example, the WTRU may determine the CSI reporting mode based on LOS probability. The WTRU may be preconfigured with a first LOS probability threshold P1 and a second LOS probability threshold P2. The WTRU may estimate a LOS probability. When the WTRU estimated LOS probability is above the first threshold P1, the WTRU may transmit the CSI report using an AI/ML mode of CSI reporting. When the WTRU estimated LOS probability is below the second threshold P2, the WTRU may transmit the CSI report using a conventional mode of CSI reporting. When the WTRU estimated LOS probability is above the second threshold P2 and below the first threshold P1, the WTRU may transmit the CSI report using a combination of an AI/ML mode of CSI reporting and a conventional mode of CSI reporting. For example, the ratio of AI/ML model of CSI reporting and conventional model of CSI reporting may be adjusted as a function of LOS probability. When the LOS probability is closer to 1, the WTRU may transmit the CSI report using AI/ML mode more frequently than using conventional CSI reporting.

WTRU position, speed, and/or direction may be reported as a function of LOS probability. A WTRU may indicate, as a part of its capability information, whether the WTRU can determine its position, WTRU speed prediction, and/or WTRU direction. The WTRU position, WTRU speed prediction, and/or WTRU direction may be absolute or relative to the gNB/TRP. The WTRU may report direction of movement in relation to the gNB/TRP. For example, the WTRU may report whether the WTRU is moving towards or away from the gNB/TRP. The WTRU may indicate the granularity of position estimation and/or WTRU speed estimation. For example, the granularity of these values may be a function of WTRU capability. The granularity of these values may be configured by the gNB. For example, the granularity of one quantity may be a function of another quantity. At higher WTRU speeds, the granularity of WTRU position estimation may be low or coarse. The WTRU may be configured to report WTRU position, WTRU speed prediction, and/or WTRU direction based on one or more preconfigured conditions. For example, the WTRU may be configured to measure and/or report direction of motion, position, and/or speed along one or more directional axis. The WTRU may report its position, the WTRU speed prediction, and/or the WTRU direction when the LOS probability exceeds a preconfigured threshold. The WTRU may be configured to perform communication delay, doppler frequency measurements. The WTRU may be configured with RSs specifically to perform such measurements. Such RSs may be configured to occur periodically, semi-persistently, or aperiodically.

UL resources for CSI reporting as a function of LOS probability may be determined. A WTRU may be configured to transmit LOS probability using a first UL resource and transmit a CSI report using a second UL resource. A preconfigured relation between the first and second UL resource may be configured. For example, the WTRU may transmit LOS probability using a first UL resource. The WTRU may be configured to receive a confirmation from the gNB. The confirmation may include additional indication(s) including the offset to a second UL resource. For example, the offset may be expressed in terms of number of symbols/slots/ms relative to the first UL resource. Additionally or alternatively, the offset may be expressed in terms of number of symbols/slots/ms relative to the gNB confirmation message. The WTRU may be configured with rules to determine the second UL resource based on the offset to the first UL resource and/or the offset to the gNB configuration message. The rules may be a function of the value of LOS probability. In examples, the WTRU may apply a first offset when the LOS probability is greater than or equal to a first LOS probability threshold or a range thereof. In examples, the WTRU may apply a second offset when the LOS probability is lower than or equal to a second LOS probability threshold or range thereof.

The WTRU may be configured to report the LOS probability, AI/ML CSI information, and/or conventional CSI information using multiple parts of a CSI report. For example, a first part of the CSI report may include a LOS probability indication. A second part of the CSI report may include a CSI report generated by an AI/ML model. A third part of the CSI report may include a CSI report generated by conventional CSI information. The WTRU may be configured with rules to determine the presence of one or more of the first part, the second part, or the third part. The presence of an AI/ML generated CSI report may be a function of LOS probability. For example, the WTRU may include an AI/ML generated CSI report when the LOS probability is above a preconfigured LOS probability threshold.

A WTRU may report information associated with WTRU location and/or movement. The information associated with WTRU location and/or movement may include one or more of the following: a LOS probability, whether a WTRU reports direction of motion and/or speed, a direction of motion, a relative position, a WTRU speed, and/or the like. The WTRU may report the information on WTRU location and/or movement by using one or more parts of CSI reporting.

The WTRU may report the information on WTRU location and/or movement by using a single part of CSI reporting. For example, the WTRU may report the information on WTRU location and/or movement (e.g., all the information on WTRU location and/or movement) (e.g., one or more of LOS probability, direction of motion, relative position, WTRU speed and etc.) in a single part to report the information to a gNB.

The WTRU may report the information on WTRU location and/or movement by using two parts of CSI reporting. For example, the WTRU may report a LOS probability in a first part and one or more of WTRU direction of motion, relative position, and/or speed in a second part. The WTRU may report whether the WTRU reports direction of motion and/or speed in a first part and one or more of WTRU direction of motion, relative position, and/or speed in a second part. For example, the WTRU may report direction of motion and/or speed in a first part and one or more of WTRU direction of motion (e.g., if not reported in the first part), relative position, and/or speed (e.g., if not reported in the first part) in a second part. The WTRU may report LOS probability and WTRU indication on direction of motion/speed report (e.g., whether the WTRU indicates or not) in a first part and one or more of WTRU direction of motion, relative position, and speed in a second part.

The WTRU may report the information on WTRU location and/or movement using three parts of CSI reporting.

For example, the WTRU may report a LOS probability in a first part, a WTRU indication on direction of motion/speed report (e.g., whether the WTRU indicates or not) in a second part, and one or more of WTRU direction of motion, speed, and relative position in a third part. In another example, the WTRU may report the LOS probability in a first part, a WTRU indication on direction of motion/speed report (e.g., whether the WTRU indicates or not) and a WTRU relative position in a second part, and WTRU direction of motion/speed in a third part.

When the WTRU reports the information on WTRU location and/or movement using two or more parts, the WTRU may determine one or more parameters of a next part (e.g., 2^{nd} part) of CSI reporting based on one or more previous parts (e.g., 1^{st} part). The one or more parameters may include whether to report the next part and/or information of the next part.

The WTRU may determine whether to report a next part of a CSI report based on a previous part of the CSI report. For example, the WTRU may indicate whether to report the next part or not. For example, the WTRU may indicate whether to indicate information in a second part or not in a first part. For example, if information (e.g., LOS probability) of the first part is larger than a predetermined threshold, the WTRU may determine to report the next part (e.g., one or more of WTRU direction of motion, relative position, and speed).

The WTRU may determine one or more parameters of a next part (e.g., 2^{nd} part) of CSI reporting based on information of the next part. For example, the WTRU may determine information of the next part based on the previous part. The WTRU may determine a set of information to report in a next part (e.g., a 2^{nd} part) based on information of the previous part (e.g., a 1^{st} part). When information (e.g., LOS probability) of the first part is greater than or equal to a threshold, the WTRU may report a first set of information (e.g., one or more of WTRU indication on direction of motion/speed report, direction of motion, relative position and WTRU speed) in the next part. When information (e.g., LOS probability) of the first part is less than the threshold, the WTRU may report a second set of information (e.g., one or more of CRI, RI, LI, PMI (including, for example, wideband PMI and/or subband PMI), CQI (including wideband CQI and/or subband CQI), L1-RSRP, L1-SINR and/or the like) in the next part. When information (e.g., LOS probability) of the first part is greater than or equal to a threshold, the WTRU may report a first set of information (e.g., one or more of direction of motion, relative position, and speed) in the next part. For example, when information (e.g., LOS probability) of the first part is less than the threshold, the WTRU may report a second set of information (e.g., WTRU relative position) in the next part. Two or more thresholds may be used. For example, when information (e.g., LOS probability) of the first part is less than a first threshold, the WTRU may report a first set of information, for example, one or more of CRI, RI, LI, PMI (including wideband PMI and/or subband PMI), CQI (including wideband CQI and/or subband CQI), L1-RSRP, L1-SINR and/or the like in the next part. When information (e.g., LOS probability) of the first part is greater than or equal to the first threshold, the WTRU may report a second set of information (e.g., WTRU relative position) in the next part. When information (e.g., LOS probability) of the first part is greater than or equal to a second threshold (e.g. such as the first threshold+X), the WTRU may report a third set of information (e.g., one or more of direction of motion, relative position, and speed) in the next part.

In one embodiment, the WTRU may report the direction of motion to the gNB. The direction of motion may be used as an input to the ML model at the gNB, for example, to predict the best beams based on the WTRU location, direction of motion, relative position, and/or the like. The WTRU may report the direction of motion periodically with periodicity configured by the gNB and/or following reception of a request from the gNB to report its direction of motion (e.g., in DCI). The WTRU may report direction of motion following detection of one or more triggers (e.g., following a detected change in the direction of motion from the previously reported direction of motion). In a solution, the WTRU may (e.g. only) be requested to report its direction of motion when the gNB is unable to infer (e.g., determine) the WTRU direction of motion from the WTRU reporting of its relative position and speed. For example, the WTRU may be configured to report direction of motion with a lower periodicity than WTRU relative position/speed.

The WTRU may report a bitwise direction of motion. For example, a value of “0” may indicate that the WTRU is moving towards the gNB while a value of “1” may indicate that the WTRU is moving away from the gNB in one or more directional axes, or vice-versa depending on the configuration. The WTRU may report the bitwise direction of motion using a flag that the WTRU reports together with, e.g., as part of the positioning information that the WTRU may already be reporting to the gNB. Presence of the flag with the positioning data may indicate that the WTRU is moving towards the gNB. The bitwise/flag indicator reporting of WTRU direction of motion may be sufficient for the gNB to have an estimate of the WTRU position (e.g., if the gNB has access to GPS and knowledge of the road networks, the WTRU reporting of its direction as away from the gNB may be sufficient for the gNB to have an estimate of the WTRU positioning). In examples, the WTRU may report direction of motion in combination with WTRU speed as the sign bit for WTRU motion.

The WTRU's reporting of its direction of motion may be enhanced to two or three directions (e.g., x, y and/or z axes w.r.t. to the gNB/TRP or any designated common reference point). In addition to using cartesian coordinates, the WTRU may also use the spherical/polar coordinate system (e.g., r, θ and/or φ from a fixed origin at gNB/TRP or any designated common reference point) to report its direction of motion. In either case, the WTRU reporting of its direction of motion may be absolute or relative to a particular gNB or TRP.

In a multi-TRP scenario, a WTRU's reporting of its direction of motion may be enhanced to two or three directions (e.g., x, y and/or z or r, θ and/or φ) e.g., depending on the number of TRPs. the WTRU may report more than 1-bit direction (e.g., 2-bit, 3-bit, etc.) corresponding to two or three directions of motion (e.g. x, y and/or z or r, θ and/or φ). In a multi-TRP scenario, a WTRU may report its position along one direction (e.g., the x axis or the radial distance r from each TRP) such that in the presence of three TRPs or more, WTRU reporting of its position in a single direction may allow the TRPs to triangulate its exact position at every reporting frequency and by extension its direction of motion. For example, a WTRU reporting of (e.g. only) its position along a single direction periodically may allow the TRPs to extrapolate and find the position in between reporting instances as well as infer the WTRU's direction of motion and/or change in direction of motion at any given time.

The WTRU may report 1-, 2-, or 3-bit direction of motion based on the number of source pilot signals it may receive from the one or multiple TRPs and/or gNBs. In a multi-TRP configuration, the WTRU may report direction of motion up to the number of sources of RS. For example, the WTRU may receive an indication of activation/deactivation for one or more RS(s) from the TRP/gNB to report bitwise direction of motion. Activation of a RS may represent a trigger for the WTRU to report its direction of motion. In examples, activation of a RS accompanied by a change in the direction of motion for the WTRU may trigger the WTRU to report its direction of motion. The WTRU may determine the number of bits for the reporting of its direction of motion based on the configured and/or activated RSs for the reporting.

A WTRU may report its direction of motion when the WTRU detects a change in the direction of motion from a previously reported direction of motion. For example, the WTRU may have received one or more thresholds from the gNB (e.g., in RRC configuration) corresponding to a change in direction of motion such that every time the WTRU detects and/or measures a change in direction of motion that exceeds the pre-configured threshold, the WTRU may report the new direction of motion to the gNB.

The WTRU may (e.g. only) report the differential in the direction of motion. For example, the WTRU may report the differential from the reported direction of motion in the previous measurement/time instance. The WTRU may have been configured to report direction of motion in more than one direction (e.g., x, y, z and/or r, θ, φ), following the detection of a change in the x and/or r direction, the WTRU may report (e.g., only report) the direction of motion for the x and/or r direction.

The WTRU may report direction of motion based on a quality of a current serving beam. For example, the WTRU may have received a threshold from the gNB corresponding to a quality metric (e.g., RSRP threshold). When the measured RSRP at the WTRU drops below the threshold, the WTRU may be configured to report the direction of motion and/or the change in the direction of motion.

The WTRU may report one or more quality measurements when the direction of motion is changed for one or more RSs, possibly in addition to the regular quality measurements made and reported by the WTRU. When the WTRU detects a change in the direction of motion, the WTRU may perform and report measurements (e.g., RSRP/RSRQ/SINR/CQI).

The WTRU may be configured to report a LOS indication/probability when the WTRU detects a change in the direction of motion. For example, the WTRU may be configured with a threshold from the gNB corresponding to the LOS probability. When the LOS probability exceeds the pre-configured threshold, the ML model may be activated and the WTRU may report the direction of motion and possibly the AIML model predicted DL beam (e.g., beam index) in the scenario where the AIML model may be at the WTRU. The WTRU may report quality measurements of the predicted DL beam (e.g., RSRP, RSRQ, SINR, CQI, etc.)

The WTRU may determine the granularity of reporting the direction of motion based on one or more parameters such as, for example, the WTRU speed of motion or whether there is a change in the direction of motion. In the absence of any change in the direction of motion, the WTRU may use a coarse reporting (e.g., 1-bit reporting) to indicate to the gNB that the direction is unchanged. When there has been a change in the direction of motion, the WTRU may use more than 1 bit for a more refined reporting (e.g., 2-bits, 3-bits) where the first bit may (e.g. still) be configured to report the detection of a change while the additional bits may identify the new direction of motion. The reporting granularity may depend on the WTRU speed of motion. For example, if the WTRU speed of motion goes is greater than a preconfigured threshold from the gNB, the WTRU may resort to a more coarse but more frequent reporting of the direction of motion.

the WTRU may receive one or more indications from the gNB on the reporting granularity to use. The indication(s) may be explicit (e.g., gNB indicating to the WTRU to use 1-bit or 2-bit) or implicit (e.g., gNB sending to the WTRU an UL grant for direction of motion reporting that may (e.g. only) be able to accommodate 1-bit reporting). The WTRU may be configured with RS(s) from the gNB to perform direction of motion measurements periodically, semi-periodically, or aperiodically (e.g., if the gNB is unable to estimate the speed of the WTRU based on the WTRU reporting of its direction of motion and relative position, the gNB may send a RS to the WTRU to (re) perform direction of motion measurements).

The WTRU may be configured with a [min, max] relative position range and corresponding reporting configuration. The WTRU may report (e.g., only report) change in direction of motion when the WTRU is either within or outside of the configured range. The WTRU may report change in direction of motion with a specific (e.g., finer) granularity and/or frequency when within the configured range and may report change in direction of motion using a coarse (e.g., more coarse) reporting granularity and/or lower reporting frequency when outside of the configured range.

A WTRU may report its relative position from the gNB/TRP, hereafter referred as relative position or just position, with a granularity level (e.g., number of bits used for reporting) and/or a position reporting range (e.g., a minimum and maximum distance from gNB which the WTRU may report). For example, the WTRU may be configured with and/or indicated a granularity level and/or a relative position reporting range (e.g., through CSI-ReportConfig). The WTRU may be configured with a set of granularity levels and/or relative position reporting ranges and may choose the granularity level and/or position reporting range based on at least one of: carrier frequency, SCS mode of operation, and LOS probability. The WTRU may report its relative position with a high granularity level and a small position reporting range for a high carrier frequency (e.g., FR-2). The WTRU may report its relative position with a low granularity level and a large position reporting range for a low carrier frequency (e.g., FR-1). The WTRU may report its relative position with a high granularity level and a small position reporting range for high SCS. The WTRU may report its relative position with a low granularity level and a small position reporting range for low SCS. The WTRU may report its relative position with a high and low granularity level for high and low LOS probability, respectively.

The WTRU may report its position based on at least one of the following: the WTRU's current relative position; the WTRU's current and past position; and the WTRU's current beam. The WTRU may report its relative position based on a distance threshold. For example, the WTRU may report its position if the WTRU's distance from the gNB is greater or less than the distance-threshold. The WTRU may be configured with a distance-threshold or may dynamically determine the distance-threshold based on the position reporting granularity level, position reporting range, carrier frequency, SCS, and/or LOS probability. The WTRU may report its position based on the difference between the WTRU's current position and a previously reported position and/or a position-threshold. For example, the WTRU may report its position if the difference between the WTRU's current position and the previously reported position is greater or less than the position threshold. The WTRU may be configured with a position-threshold or dynamically determine the position-threshold based on the position reporting granularity level, position reporting range, carrier frequency, SCS, and/or LOS probability. The WTRU may report the difference between the current position and the previously reported position. The WTRU may report its position based on the beam quality (e.g., RSRP, RSRQ, CQI, SINR). For example, the WTRU may report its position when the quality of a current beam falls below a beam-quality threshold.

The WTRU may report its position when the WTRU's current beam changes. For example, the WTRU may report its position when a different TCI-state is activated. The WTRU may report its estimated relative position range. For example, the WTRU may report its estimated minimum and maximum distance from the gNB. The WTRU may report its relative position range estimated within a time period. For example, the WTRU may determine the range estimation time period based on the position reporting granularity level, carrier frequency, SCS, and/or LOS probability. The WTRU may be configured with a time period for position range estimation. The WTRU may report its position and position range in one or more positional/directional axes (e.g., x, y and/or z).

The WTRU may determine a number of directional axes for reporting based on the number of RSs received from different sources. The WTRU may determine the number of sources of RS based on the number of configured TRPs. The WTRU may report its relative position in two directional axes for a 2-TRP configuration. The WTRU may report its relative position and/or relative position in the directional axes for which the WTRU estimates the change in position greater than the distance-threshold. The WTRU may report its relative position in the directional axes for which the WTRU's direction of motion changes.

A WTRU may determine a coordinate system. The WTRU may be configured with and/or indicated a coordinate system for position reporting. The WTRU may recommend and/or indicate a coordinate system for position reporting. For example, the WTRU may recommend a coordinate system based on at least one of the following: the WTRU's position in one or more directional axes (e.g., x, y, and/or z), the WTRU's angle from the gNB, the WTRU's radial distance from the gNB, a LOS probability, and/or a quality of a RS (e.g., RSRP. SINR, CQI).

The WTRU may recommend a coordinate system based on one or more configured and/or indicated conditions to the WTRU. The WTRU may indicate and/or recommend a coordinate system based on the types of position parameters that may vary with time. The WTRU may recommend the polar coordinate system if the change in radial distance of the WTRU from the gNB is less than a radius-threshold. The WTRU may recommend the polar coordinate system if the change in angle of the WTRU from the gNB is less than an angle-threshold. The WTRU may recommend the cartesian coordinate system if the change in one or more position directions (e.g., x, y, or z) is less than a distance-threshold.

A WTRU may report its speed. The WTRU may estimate, measure, and/or determine a (e.g. average) speed/velocity (e.g., in the context of mobility measurements) of the WTRU. One or more of the following may apply: explicit/absolute speed measurement; differential/delta speed measurement; and implicit speed measurement:

In an example, explicit/absolute speed measurement may apply. For example, the WTRU may measure/determine the absolute speed/velocity (e.g., by using speed measurement equipment/functions, e.g., speed-meter in vehicles measuring speed in units of m/s, km/h, and so forth).

In an example, differential/delta speed measurement may apply. For example, the WTRU may estimate/determine in case the WTRU is accelerating and/or slowing down. In an example, the WTRU may measure/determine the changes/difference in the measured speed in the context of differential speed or the delta speed. In an example, the WTRU may determine the differential/delta speed using one or more equipment, function, and so forth (e.g., differential speed sensor in vehicles).

In an example, implicit speed measurement may apply. For example, the WTRU may measure, estimate, or determine the speed/velocity based on one or more of the channel properties (e.g., Doppler shift). In an example, the WTRU may be configured with one or more reference signals (e.g., CSI-RS, phase tracking reference signal (PTRS), and so forth). In an example, the WTRU may use cyclic prefix (CP) for the frequency measurements. In an example, the WTRU may measure the changes in the frequency (e.g., due to Doppler shift) and determine the speed/velocity accordingly.

The WTRU may report (e.g., efficiently report) the measured and/or determined (e.g. differential) speed/velocity. The WTRU may measure and/or determine the (e.g. average) speed/velocity and/or a differential speed/velocity. The WTRU may be configured or determine (e.g., based on AI/ML model) one or more estimation/measurement parameters. One or more of the following may apply: measurement parameters (e.g., Timing interval) and thresholds/hysteresis levels, and/or the like.

The WTRU may be configured and/or determine measurement parameters (e.g., timing interval). For example, the WTRU may be configured or determine one or more parameters (e.g., time-intervals) to measure/average (e.g., differential) speed. One or more of the following may apply: speed, channel quality, beam width, cell size, and/or the like. The WTRU may be configured to determine a speed associated with the WTRU. For example, the WTRU may determine one or more time intervals based on the measured/determined speed/velocity. The WTRU may be configured or determined to use a first parameter (e.g., shorter time-interval) to measure/average the (e.g. differential) speed, when the measured (e.g. differential) speed is greater than a configured/determined first threshold. The WTRU may use a second parameter (e.g., longer) to measure/average the (e.g. differential) speed, when the measured (e.g. differential) speed is less than a configured/determined second threshold. The WTRU may be configured to determine channel quality. For example, the WTRU may be configured to determine one or more measurement parameters (e.g., time intervals) based on one or more of the channel quality parameters (e.g., RSRP, SINR, CQI, and so forth). The WTRU may determine or be configured to use a first parameter (e.g., shorter time-interval) to measure/average the (e.g. differential) speed, when one or more of the measured/determined channel quality parameters are less than a first threshold (e.g., due to low channel quality). The UE may determine or be configured to use a second parameter (e.g., longer time-interval) to measure/average the (e.g. differential) speed, when one or more of the measured/determined channel quality parameters are greater than a second threshold (e.g., implying a good channel quality).

The WTRU may be configured to determine a beamwidth. The WTRU may be configured or determine one or more parameters (e.g., time intervals) based on the beamwidth (e.g., based on frequency range (FR), SCS, and so forth). The WTRU may determine or be configured to use a first parameter (e.g., shorter time-interval) to measure/average the (differential) speed, when the WTRU is operating in a first frequency range (e.g., FR2) or a first beamwidth (e.g., narrow beamwidth). The WTRU may determine or be configured to use a second parameter (e.g., longer time-interval) to measure/average the (e.g. differential) speed, when the WTRU is operating in a second frequency range (e.g., FR1) or a first beamwidth (e.g., wide beamwidth).

The WTRU may be configured to determine a Cell size. The WTRU may determine or be configured to use a first parameter (e.g., shorter time-interval) to measure/average the (e.g. differential) speed, when the (e.g. serving) cell may be within a determined/configured cell size, and use a second parameter (e.g., longer time-interval), otherwise. The WTRU may be configured to determine one or more thresholds and/or hysteresis levels. The WTRU may determine (e.g., based on AI/ML model) or be configured with one or more threshold limits for determining the speed/velocity measurement parameters.

The WTRU may determine or be configured with one or more hysteresis levels. The WTRU may determine a second limit/threshold based on a determined/configured first limit/threshold and/or respective determined/configured hysteresis. The WTRU may be configured with or determine one or more of the thresholds and/or hysteresis levels based on one or more parameters (e.g. as described herein) (e.g., speed/velocity, channel quality, beamwidth, cell size, and so forth).

A WTRU may be configured with one or more resources to report the measured/determined (e.g. differential) speed/velocity. For example, the WTRU may receive the reporting configuration based on gNB indication configured by RRC or signaled by MAC CE or DCI. The WTRU may be configured to report in periodic, semi-persistent, and/or aperiodic time instances.

A WTRU may receive one or more configurations on the type of report indication. The WTRU may be configured for report indication with a first type (e.g., absolute value) or a second type (e.g., reporting differential values, e.g., based on a (reported) reference). For example, the reporting type indication may be a flag, where 0 may mean reporting based on the first type (e.g., absolute value), and 1 may mean reporting based on the second type (e.g., differential values). The WTRU may be configured to report speed/velocity based on the first type (e.g., absolute value) to set/indicate/identify the reference speed. The WTRU may be configured to report with the second type (e.g., differential values) and based on the (e.g. previously) reported reference value.

In reporting the measured/determined values, one or more of the following may apply: absolute value reporting and differential value reporting. The WTRU may determine (e.g., based on AIML model) or be configured with one or more thresholds/limits, such as minimum, maximum, and/or the reporting granularity. The WTRU may report the measured/determined absolute value (e.g., for speed/velocity) based on the configured thresholds/limits (e.g., via allocated/scheduled number of the bits/symbols). The WTRU may be configured or determine one or more of the thresholds/limits (e.g., reporting granularity) based on one or more parameters (as described herein) (e.g., speed/velocity, channel quality, beamwidth, cell size, and so forth). The WTRU may be configured or determine the reporting granularity level (e.g., for speed) based on the configured thresholds/limits (e.g., minimum and/or maximum speed) and one or more configured parameters (e.g., the granularity level of position reporting). The WTRU may determine or be configured to report differential values (e.g., for speed/velocity), where the WTRU may report the change/difference compared to the previous reported value(s).

A WTRU may determine to (e.g., trigger to) report respective measured/determined (e.g. differential) speed/velocity. The WTRU may send a request (e.g., scheduling request (SR) to gNB) to transmit/send a respective report. For example, one or more of the following may apply: absolute value, differential value, channel quality, thresholds, and/or the like.

A WTRU may determine to (e.g., trigger to) report an absolute value of speed/velocity. For example, the WTRU may determine or be configured to report the absolute value of speed/velocity when the measured/determined value (e.g., speed/velocity) is greater or less than a configured and/or determined threshold/limit. The WTRU may determine to report the measured/determined (e.g. absolute) value (e.g. for the speed). The UE may determine to report a flag, where the value 1 indicates that the absolute value (e.g., of speed/velocity) is greater than a threshold.

A WTRU may determine to (e.g., trigger to) report a differential value of speed/velocity. For example, the WTRU may determine or be configured to report the differential value of speed/velocity when the change/difference between the measured/determined values (e.g., speed/velocity) in one or more consecutive time instances is greater than a configured/determined threshold/limit. For example, the WTRU may determine to report the measured/determined differential value (e.g. for the speed). The WTRU may determine to report a flag, where the value 1 indicates that the change/difference in the measured/determined value (e.g., of speed/velocity) is greater than a threshold.

A WTRU may determine to (e.g., trigger to) report speed/velocity based on channel quality. For example, the WTRU may determine or be configured to report (e.g., speed/velocity) when the WTRU determines a decrease in channel quality. The WTRU may determine to report (e.g., speed/velocity) when the WTRU determines that one or more measured CSI parameters are not in respective acceptable range(s) (e.g., received power (e.g., RSRP, SINR, CQI, and so forth) is lower than a respective threshold). In a case of decreased channel quality, the WTRU may determine to report (e.g., speed/velocity), if (e.g. only if) the measured value (e.g., speed/velocity) is greater or less than a respective threshold.

A WTRU may determine to (e.g., trigger to) report speed/velocity based on one or more thresholds. For example, the WTRU may determine or be configured to report (e.g., speed/velocity) based on one or more thresholds/limits, where the thresholds/limits may be determined/configured based on one or more parameters (as described herein) (e.g., speed/velocity, channel quality, beamwidth, cell size, and so forth).

Additionally or alternatively, the WTRU may report speed/velocity implicitly (e.g., based on the position). For example, the WTRU may determine WTRU's position in one or two configured/determined time instances. The WTRU may report the exact positions and/or the relative distance between the WTRU's position at the two configured/determined time instances (e.g., two consecutive measurements). The WTRU may report the time interval between consecutive measurements (e.g., in number of symbols, slots, and/or exact time).

One or more WTRU actions may be based on estimated position and speed. A WTRU may perform conditional beam measurement and/or reporting. One or more beam areas may be configured. For example, the WTRU may be configured with a set of beams or Reference Signals (RSs). Each beam or RS may be associated with an area (e.g. a set of longitudinal or latitudinal or height or x, y, and z coordinates). Each beam area may be associated with one or more beams or RSs. Each beam or RS may be associated with one or more beam areas.

The WTRU may monitor one or more RSs associated with a beam when the WTRU is in the associated area and/or if the WTRU determines it is in the associated area. The WTRU may report measurements on one or more RSs if it is in the associated area and/or if the WTRU determines it will be in the associated area.

A WTRU may be configured with one or more beam areas that may be associated with a beam and/or with an RS. The WTRU may determine the one or more beam areas associated with a beam and/or with an RS. For example, the WTRU may input into a module the measurements of a set of RSs and an associated WTRU position. The module may be an AI/ML model, and such inputting may be considered training the AI/ML model. The WTRU may input into the module a set (e.g., new set) of measurements on the set of RSs when the WTRU position changes. After sufficient measurement and location samples have been obtained, the module may provide an association between a beam or RS and an area.

A WTRU may determine an RS to be measured and/or reported. The WTRU may be configured with a set S of RSs. The WTRU may be indicated that a subset s1 of RSs may be activated (or transmitted by the gNB) and may be received by the WTRU. The WTRU may select a subset s2 of RSs on which to perform measurements. The WTRU may select a subset s3 of RSs, for which to report measurements. The WTRU may determine a set s4 of RSs (e.g. RSs not included in s1) for which it may request the gNB to activate (or begin transmission of) RSs. In examples, an RS set or subset may include one or more RS indices.

A WTRU may determine the contents of one or more of the subsets of RSs. The WTRU may indicate at least one of the subsets of RSs periodically or when the contents of the subset may change. The WTRU may indicate to the gNB the current elements (e.g. RS indices) of a subset or the current subset. The WTRU may indicate to the gNB one or more predicted future elements of a subset or a predicted future subset. A predicted future subset may be associated with a specific active time period. An indication of a predicted future subset may include a time period for when the subset may need to be activated.

A WTRU may determine the elements (or size) of an above subset, or a subset, or the set of RSs/beams to measure, or the set of RSs/beams to report measurements for, or the set of RSs/beams to request transmission from the gNB, based on at least one of: the speed, direction of motion or position of the WTRU; an upcoming or predicted speed or direction of motion or position of the WTRU; a beam area; a change in beam area; an upcoming change in beam area (For example, based on the WTRU's current location and predicted upcoming location. For example, the WTRU may determine it may be about to undergo a change in beam area. For example, the WTRU may determine to perform one of the above actions based on a predicted upcoming change in beam area or the timing of an upcoming change in beam area); the estimated accuracy of the speed or direction of motion or position of the WTRU; the LOS probability of an RS or beam; the LOS probability of an associated RS or beam (For example, a WTRU may perform a measurement on a first RS and may determine or predict the LOS probability of an associated or second RS); a measurement on an RS (For example, based on a measurement on an RS, the WTRU may determine whether to include the same or another RS in a subset. For example measurement may include at least one of: RSRP, RSSI, RSRQ, PL, CQI, RI, PMI, LI, CRI, SINR, doppler spread, doppler shift, average delay, delay spread, angle of arrival, and/or the like); the size of the set of configured RSs; the number of RSs configured per beam area; the performance of transmissions on a beam (for example, the performance may be determined by at least one of: throughput, BLER, HARQ-ACK performance, latency, and/or the like); the timing of a report; whether a report is periodic or aperiodic or semi-persistent; and the cause of a report (For example, the above may be determined based on if the report is caused by beam failure detection).

A WTRU may determine the number of RSs per beam area to measure or report as a function of the speed or direction of motion or position (or accuracy thereof). For example, if a WTRU is moving faster than a threshold value, the WTRU may report measurements for a first (e.g. small) number of RSs per beam area. This may enable the WTRU to report RSs for more beam areas given that the WTRU may be changing beam areas rapidly. If a WTRU is moving slower than a threshold value, the WTRU may report measurements for a second (e.g. larger) number of RSs per beam area. This may allow the total number of RSs reported to remain constant. The WTRU may determine the total number of RSs monitored or reported as a function of the speed or direction of motion or position (current or future).

A WTRU may determine to add or drop RSs to measure and/or report as a function of speed, direction of motion, and/or a future position. For example, based on a current position, speed, and/or direction of motion a WTRU may predict a future position, speed, and/or direction of motion. The WTRU may determine to add one or more RSs or start measuring or reporting RSs in beam areas where the WTRU is positioned in a subsequent time period. The WTRU may determine to drop one or more RSs or stop measuring or reporting RSs in beam areas where the WTRU is longer be positioned in a subsequent time period.

A measurement report may be segmented into multiple parts. For example, each part of the measurement report may be associated with a different subset. The measurement report may include a first part providing feedback for one or more RSs associated with a current position and/or beam area of a WTRU. The measurement report may include a second part providing feedback for one or more RSs associated with a future position and/or beam area of a WTRU. The measurement report may include a third part providing feedback for one or more RSs associated with a position or beam area that the WTRU may be leaving. The feedback report may indicate the indices of the RSs or beams for each of the scenarios described herein and/or for one or more subsets described herein.

Adaptation of reporting parameters may be performed. A WTRU may determine the parameters associated with the reporting of a measurement on an RS as a function of the current or future speed, current or future direction of motion, current or future location, and/or current or future beam area. The parameters associated with the reporting of a measurement on an RS may include at least one of: timing, periodicity, offset, PUCCH resource, PUCCH format, priority, transmit power, and/or the like. The WTRU may determine the reporting parameters of an RS based on at least one of the above triggers/conditions described herein for the reporting of subsets.

A WTRU may report one or more measurements taken on one or more RSs associated with a first set of beam areas with a first periodicity and offset. The WTRU may report the one or more measurements taken on RSs associated with a second set of beam areas with a second periodicity and offset. The first set of beam areas may include the beam area where the WTRU may be currently located and a set of beam areas where the WTRU may be located in the future. The second set of beam areas may include one or more (e.g., all other) beam areas not in the first set, for which the WTRU has RS configuration. The first reporting periodicity may be shorter than the second reporting periodicity. Being configured with different reporting periodicities may enable the WTRU to report higher quality feedback for RSs located in beam areas where the WTRU is or may be. The WTRU may not report measurements for RSs associated with a second set of beam areas.

The measurement reports may include one or more RS indices or beam area indices, for example, to indicate the RSs in each set of beam areas. A WTRU may determine the RSs associated with a first set of beam areas and/or the WTRU may determine the first set of beam areas based on a current or future speed, a current or future direction of motion, and/or a current or future location. For example, the first set of beam areas may include the beam area where the WTRU may be currently located and one or more beam areas where the WTRU may be located in a future time instance (e.g. beam areas in the direction of motion of the WTRU). The WTRU may update the first set of beam areas or RSs associated with the first set of beam areas, for example, when the WTRU determines a change (e.g. a change greater than threshold) in any of speed, direction of motion, or location.

The WTRU may determine one or more measurement or reporting parameters of one or more RSs associated with a beam area as a function of the accuracy of the current or future speed, current or future direction of motion, current or future location, and/or current or future beam area. The accuracy of the current or future speed may be determined as a function of the LOS probability. The WTRU may determine the one or more RSs associated with a first or second set of beam areas and/or the first or second set of beam areas as a function of the accuracy of the current or future speed, current or future direction of motion, current or future location, and/or current or future beam area. The accuracy of the current or future speed may be determined as a function of the LOS probability.

Adaptation of transmission resources may be provided. A WTRU may determine a set of resources or beam(s) on which to receive a transmission or perform a transmission as a function of current or future speed, current or future direction of motion, current or future location, and/or current or future beam area. The WTRU may be configured to receive one or more PDSCH transmissions on a set of TCI states. The WTRU may determine the appropriate TCI state to use as a function of the current or future speed, current or future direction of motion, current or future location, and/or current or future beam area. The WTRU may transmit PUSCH or PUCCH (e.g. HARQ feedback) on a resource determined from the current or future speed, current or future direction of motion, current or future location, and/or current or future beam area. A WTRU may indicate to the gNB the set of desired TCI states. The WTRU may indicate to the WTRU the set of currently desired TCI states and/or the set of desired TCI states for a future time. A WTRU may indicate and/or request duplication of transmissions on multiple beams if the speed, location, and/or direction of motion is above a respective threshold value(s). The WTRU may indicate and/or request duplication of transmission on multiple beams if the accuracy of the speed, location, and/or direction of motion is less than the respective threshold value(s).

A WTRU may report a best DL beam for a future time instant. An AI/ML model may predict the best DL beam for a future time instant based on a predicted position and/or speed/velocity of a WTRU. A WTRU may be configured with an AI/ML model to predict the mapping between a WTRU's future location and/or the appropriate TCI state to determine the QCL information of the reference signals (e.g., CSI-RS reception, TRS reception, DM-RS of PDCCH/PDSCH reception).

A gNB may train an AI/ML model to predict the relationship between a WTRU's location and the TCI state or the relationship between the WTRU's location and the TCI state. One or more WTRUs associated with the gNB may report to the gNB the LOS probability associated with different beam resources with which each WTRU may be configured. The one or more WTRUs may report a direction of WTRU's motion, a speed of the WTRU's motion, a relative position of the WTRU, and/or beam measurements (e.g., L1-RSRP, CQI, PMI, RSRQ, SINR), of configured set of beam resource sets. A gNB may use one or more reported measurements/estimates from one or more WTRUs to train the AI/ML model.

The WTRU may receive the trained AI/ML model from the gNB and the WTRU may use the model to predict the relationship between the WTRU's location and the TCI states based on previous and/or current LOS probability of one or more beam resources, direction of WTRU's motion, speed of the WTRU's motion, relative position of the WTRU, and/or beam quality measurements (e.g., L1-RSRP, CQI, PMI, RSRQ, SINR). Such TCI states predicted based on AI/ML model may be referred to herein as future TCI states.

A WTRU may train the AI/ML model used for TCI state prediction based on one or more of position of the WTRU, speed of the WTRU, direction of motion of the WTRU, and/or LOS probability of one or more beam resources. The WTRU may use the trained AI/ML model to predict the relationship between the WTRU's location and the TCI states based on previous and/or current LOS probability of one or more beam resources, direction of WTRU's motion, speed of the WTRU's motion, relative position of the WTRU, and/or beam quality measurements (e.g., L1-RSRP, CQI, PMI, RSRQ, SINR). Such TCI states predicted based on AI/ML model may be referred to herein as predicted TCI states.

TCI state prediction may be based on AI/ML model. A WTRU may indicate one or more predicted TCI states to the gNB X symbols/slots/ms in advance. A WTRU reporting of the predicted TCI state(s) may be conditioned on a LOS probability threshold (P_{LOS-TH}), that is configured/indicated by the gNB or determined by the WTRU. If the LOS probability≥P_{LOS-TH}, the WTRU may report the predicted TCI state(s) to the gNB. For example, when the LOS probability is greater than or equal to P_{LOS-TH}, the WTRU may determine a time duration from a set of time durations based on the estimated LOS probability. The set of time durations may be received via configuration information as described herein. The WTRU may predict a future TCI state applicable to an associated time instance. The associated time instance may be determined based on a current time and the determined time duration. The WTRU may send the predicted future TCI state and the associated time instance to the network. If the LOS probability<P_{LOS-TH}, the WTRU may not report the predicted TCI state(s) to the gNB. For example, if the LOS probability<P_{LOS-TH}, the WTRU may indicate the LOS probability to the gNB. The WTRU may use one or a combination of the following examples to determine the time duration, X.

The WTRU may receive the time duration, X from the gNB via one or more of RRC signaling. MAC-CE indication, or DCI indication. For example, a WTRU may be configured with a fixed value of X by RRC signaling or MAC-CE indication. A WTRU may be configured with a plurality of values for X (e.g., a set of time durations) by RRC signaling and one of the plurality of values may be dynamically indicated by a MAC-CE. The WTRU may report the predicted TCI state/future TCI states in one or more UL resources (e.g., a PUCCH resource, a PUSCH resource, a PRACH resource, and/or the like). The one or more UL resources may be indicated by using one or more of a RRC message, a MAC-CE, or DCI. The WTRU may determine X duration based on LOS probability of a beam resource. For example, X=X₁ for LOS probability P_{LOS1} and X=X₂ for LOS probability P_{LOS2} where X₁<X₂ and P_{LOS1}<P_{LOS2}. In examples, the WTRU may receive X₁, X₂, and P_{LOS1}, P_{LOS2} via RRC signaling/MAC-CE indication.

The WTRU may determine X based on a LOS probability of a beam resource and the WTRU's mode of operation (e.g., AI/ML based beam management mode or conventional beam management mode of operation). When the WTRU is in conventional beam management mode and the WTRU estimates the LOS probability≥P_{LOS-TH}, the WTRU may select a first value (e.g., a larger value) of X out of possible set of candidate values (e.g., the WTRU is configured with or the WTRU determined). The WTRU may change the mode of operation from conventional beam management mode to AI/ML based beam management mode based on measurements within the determined X (e.g., the first value) symbols/slots/ms.

When the WTRU is in AI/ML based beam management mode and the WTRU estimates the LOS probability<P_{LOS-TH}, the WTRU may choose the first value (e.g., a larger value) of X out of possible set of candidate values. The WTRU may change the mode of operation from AI/ML based beam management mode to conventional beam management mode (e.g., based on measurements within the determined X symbols/slots/ms). When the WTRU is in AI/ML based beam management mode and the WTRU estimates the LOS probability≥P_{LOS-TH}, the WTRU may select a second value (e.g., a smaller value) of X out of possible set of candidate values. When the WTRU is in conventional mode and the WTRU estimates the LOS probability<P_{LOS-TH}, the WTRU may choose the second value (e.g., a smaller value) of X out of possible set of candidate values.

An AI/ML Model may be retrained. In an example, an AI/ML model may be trained at a gNB and transferred to a WTRU. One or more of the following solutions may be used to estimate the need for AI/ML model retraining and/or request the gNB for a new model.

A WTRU may indicate and/or request the gNB to retrain an AI/ML model and perform a model transfer based on the accuracy of TCI state/beam predictions. For example, the WTRU may compute a number of instances. An instance may be when a difference between the quality (e.g., L1-RSRP, RSRQ, SINR, PMI, CQI) of the best predicted beam by the AI/ML model and the quality of the best beam measured by the WTRU exceeds a preconfigured/indicated/predetermined threshold (T_{Conf}). The WTRU may receive T_{Conf} via one or more of RRC signaling, MAC-CE, and DCI indication. When the number of the instances (e.g., the difference>T_{Conf}) is larger than (or equal to) a preconfigured number (N) within a configured/indicated time interval (T), the WTRU may indicate and/or request the gNB to retrain the AI/ML model. For example, the WTRU may indicate and/or request using one or more of UL resources (e.g., one or more of PUCCH resources, PUSCH resources, MAC-CEs and RRC messages). The indication may be a 1-bit indication (e.g., 0: keep the current AI/ML model and 1: retrain the AI/ML model). The WTRU may receive N and T via one or more of RRC signaling, MAC-CE indication, and DCI.

For an AI/ML model trained at the WTRU, one or more of the following solutions may be used to estimate and/or determine the need for and/or perform AI/ML model retraining. In examples, the WTRU may retrain the AI/ML model when a gNB updates the TCI state(s) the WTRU is configured and/or indicated with (e.g., via one or more of RRC, MAC CE and DCI).

The WTRU may retrain the AI/ML model based on the accuracy of its TCI state predictions. For example, the WTRU may compute the number of instances where the difference between the quality (e.g., L1-RSRP, RSRQ, SINR, PMI, CQI) of the best predicted beam by the AI/ML model and the quality of the best beam measured by the WTRU exceeds a preconfigured threshold (T_{conf}). When the number of instances on the difference of the quality exceeds T_{conf} is greater than a preconfigured number (N) within a configured time interval (T), the WTRU may initiate retraining AI/ML model, the WTRU may request and/or indicate to the gNB that the WTRU initiated a procedure to retrain the AI/ML model. The indication may be a 1 bit indication (e.g., 0 is associated with no retraining by the WTRU, and 1 is associated with retraining by the WTRU).

Additionally or alternatively, the WTRU may indicate that the WTRU switched to conventional beam management mode. For example, the indication may be a 1 bit indication. For example, a value of 0 may be associated with no switching and a value of 1 may be associated with switching from a 1^{st} mode to a 2^{nd} mode (e.g., AI/ML mode or conventional mode to conventional mode or AI/ML mode). The WTRU indication may be a 1 bit indication to indicate that the level of accuracy of AI/ML model may not be sufficient.

1. A wireless transmit/receive unit (WTRU) comprising:
a processor configured to:
receive first configuration information associated with a channel state information reference signal (CSI-RS) resource set, a set of transmission configuration index (TCI) states, a set of probability thresholds, and a set of time durations;
determine one or more CSI-RS measurements associated with one or more of the CSI-RSs in the CSI-RS resource set, wherein the one or more CSI-RS measurements are determined based on a received TCI state;
estimate a line of sight (LOS) probability of the WTRU based on the one or more CSI-RS measurements;
determine whether the estimated LOS probability is greater than or equal to a probability threshold from the set of probability thresholds; and
in response to determining that the estimated LOS probability is greater than or equal to the probability threshold:
determine a time duration from the set of time durations based on the estimated LOS probability;
predict a future TCI state applicable to an associated time instance, wherein the associated time instance is determined based on the current time and the determined time duration; and
send the predicted future TCI state and the associated time instance to the network.

2. The WTRU of claim 1, wherein the processor is further configured to in response to determining that the estimated LOS probability is less than the probability threshold, send an indication that the estimated LOS probability is less than the probability threshold to the network.

3. The WTRU of claim 1, wherein the processor is further configured to send CSI information of a subset of the one or more measured CSI-RSs based on second configuration information.

4. The WTRU of claim 3, wherein positioning information of the WTRU comprises one or more of a direction of motion, a position, or a speed.

5. The WTRU of claim 1, wherein the one or more CSI-RS measurements comprises one or more of a reference signal received power (RSRP), a signal to interference noise ratio (SINR), a reference signal received quality (RSRQ), or a channel quality indicator (CQI).

6. The WTRU of claim 1, wherein the processor is further configured to estimate the LOS probability of the WTRU, a direction of motion of the WTRU, a position of the WTRU, and a speed of the WTRU in a plurality of directional axes with respect to a second device.

7. The WTRU of claim 1, wherein the estimated LOS probability is associated with the received TCI state.

8. The WTRU of claim 1, wherein the estimated LOS probability is associated with an intermediate TCI state between the received TCI state and the future TCI state.

9. The WTRU of claim 1, wherein the determined time duration is proportional to the estimated LOS probability.

10. The WTRU of claim 1, wherein the set of time durations comprises a first time duration associated with a first range of LOS probabilities and a second time duration associated with a second range of LOS probabilities.

11. A method performed by a wireless transmit/receive unit (WTRU) comprising:
receiving first configuration information associated with a channel state information reference signal (CSI-RS) resource set, a set of transmission configuration index (TCI) states, a set of probability thresholds, and a set of time durations;
determining one or more CSI-RS measurements associated with one or more of the CSI-RSs in the CSI-RS resource set, wherein the one or more CSI-RS measurements are determined based on a received TCI state;
estimating a line of sight (LOS) probability of the WTRU based on the one or more CSI-RS measurements;
determining whether the estimated LOS probability is greater than or equal to a probability threshold from the set of probability thresholds; and
on a condition that the estimated LOS probability is greater than or equal to the probability threshold:
determining a time duration from the set of time durations based on the estimated LOS probability;
predicting a future TCI state applicable to an associated time instance, wherein the associated time instance is determined based on the current time and the determined time duration; and
sending the predicted future TCI state and the associated time instance to the network.

12. The method of claim 11, the method further comprising, on a condition that the estimated LOS probability is lower than the probability threshold, sending an indication that the estimated LOS probability is less than the probability threshold to the network.

13. The method of claim 11, further comprising sending CSI information of a subset of the one or more measured CSI-RSs based on second configuration information.

14. The method of claim 13, wherein positioning information of the WTRU comprises one or more of a direction of motion, a position, or a speed.

15. The method of claim 11, wherein the one or more CSI-RS measurements comprises one or more of a reference signal received power (RSRP), a signal to interference noise ratio (SINR), a reference signal received quality (RSRQ), or a channel quality indicator (CQI).

16. The method of claim 11, further comprising estimating the LOS probability of the WTRU, a direction of motion of the WTRU, a position of the WTRU, and a speed of the WTRU in a plurality of directional axes with respect to a second device.

17. The method of claim 11, wherein the estimated LOS probability is associated with the received TCI state.

18. The method of claim 11, wherein the estimated LOS probability is associated with an intermediate TCI state between the received TCI state and the future TCI state.

19. The method of claim 11, wherein the determined time duration is proportional to the estimated LOS probability.

20. The method of claim 11, wherein the set of time durations comprises a first time duration associated with a first range of LOS probabilities and a second time duration associated with a second range of LOS probabilities.
